(19) United States
(12) Patent Application Publication
(10) Pub. No.: US 2012/0014056 A1
(43) Pub. Date: Jan. 19, 2012

(54) Rotating docking station for portable electronic devices

(76) Inventors: Jinsaun Chen, Chung Ho City (TW); Kuo Kang Lee, Chung Ho City (TW); Tzu Chun Liang, Chung Ho City (TW)

(21) Appl. No.: 12/805,185

(22) Filed: Jul. 16, 2010

(51) Int. Cl. G06F 1/16

(52) U.S. Cl. 361/679.41

(57) ABSTRACT

A docking station for connection between one or more portable electronic devices and an external device for networks. The docking station includes a docking surface having one or more connectors adapted to be connected to the portable electronic devices, the docking surface rotating with respect to a base section.

### FIELD OF THE INVENTION

The present invention is directed to a docking station for connection to a plurality of electronic devices.

### BACKGROUND OF THE INVENTION

Hand-held portable electronic devices, such as, but not limited to SMART phones, or MP3 players have become ubiquitous in the present marketplace. Generally, these devices operate utilizing rechargeable batteries. Additionally, these devices are designed to upload or download various applications or media, usually by being connected to a USB port. In both of these situations, when a battery is included in the devices, as well as uploading and downloading programs and other media, these devices must be connected to a source of power as well as have access to the applications as well as media, generally by being connected to, for example, a USB port. Docking stations have been developed which would allow these types of connections to the electronic portable devices to be made. Most common docking stations are designed to simply act as a conduit between the portable devices and the power charger, the USB port, as well as speakers. Some docking stations additionally offer further features like an alarm, a radio and a remote control. Generally, these present day docking stations do not allow the consumer to dock more than one electronic device at any one time. Consumers who have more than one portable electronic device must synchronize the connection of their multiple portable electronic devices to the single connector attached to the present day docking stations. This would force the consumer to rotate the application of their portable electronic devices to the single connector associated with the prior art docking stations. This would also prevent the consumers from more economically utilizing their time during when each of their portable electronic devices would have to be attached in sequence to the single connector provided on a docking surface of the docking station.

### SUMMARY OF THE INVENTION

The present invention is directed to the deficiencies of the prior art by providing a docking station provided with a docking surface having a plurality of connectors to simultaneously mount a plurality of portable electronic devices thereto. This would allow the consuming public to physically access each portable electronic device at their best comfort by providing a docking station having a rotatable docking surface.

The present invention provides a docking station having a docking or mounting surface thereon with one or more connectors extending upwardly therefrom to support and electrically connect multiple portable electronic devices to a charging station, a USB port or other devices. The docking station is provided with a pillar between the mounting surface and a base, allowing the mounting surface to rotate horizontally about a vertical axis with respect to the base. A USB data port connects the docking surface to a network or other external devices such as, but not limited to a personal computer. The docking station also includes a power jack for connecting the portable electronic devices through a connector provided on the docking surface to an external power supply for the purpose of charging each of the portable electronic devices. It is noted that the present invention would allow the plurality of portable electronic devices to be simultaneously connected to the USB data port, the external power supply, as well as other similar devices.

The present invention would also allow direct and easy physical access to each of the mounted portable electronic devices by rotating the docking surface of the docking station with respect to the base of the docking station.

Additionally, according to the present invention, the connector to which each of the portable electronic devices would be connected is hardwired to printed circuit boards which in turn are connected to the USB data port outlet, an outlet connected to the external power supply, as well as other similar devices.

### BRIEF DESCRIPTION OF THE DRAWINGS

These and other objects of the present invention will become apparent and more easily appreciated from the following description of the presently preferred exemplary embodiments, taken in conjunction with the accompanying drawings in which:

FIG. 1 is a perspective drawing showing the docking station of the present invention;

FIG. 2 is a perspective drawing showing the docking station of the present invention in use;

FIGS. 3A-3C, 4A-4C and 5A-5C show top, profile and side views of the present invention;

FIG. 6 shows an exploded view of the components of the docking station of the present invention; and

FIG. 7 shows a sectional view of the docking station according to the present invention.

### DETAILED DESCRIPTION OF THE PRESENT INVENTION

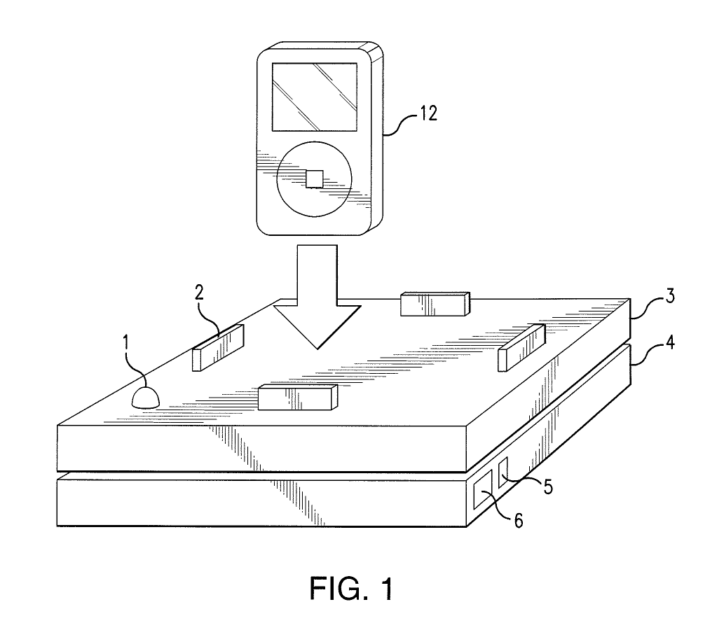

FIG. 1 shows some of the major components of the docking station of the present invention as being utilized with, for example an electronic device 12, such as an MP3 player. The docking station is provided with a docking surface 3 having a plurality of connectors 2 extending upwardly through the docking surface 3. Although FIG. 1 shows one configuration of the docking station consisting of four equal sides, making a square, the exact shape of the docking station is not important. For example, the docking surface 3 could be in the shape of a circle or any polygon having various surface shapes, such as the square shown in FIG. 1, a triangle, a pentagon, hexagon, etc. Additionally, the docking surface 3 could be a pyramid-shaped platform having at least one connector 2.

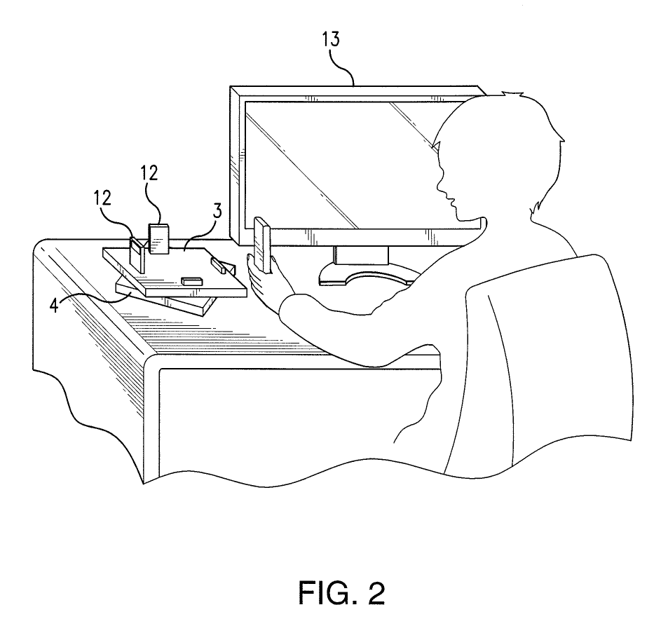

The docking surface 3 is integrally connected to a base section 4. Although FIG. 1 illustrates that the shape of both the docking surface 3 and the base 4 are the same, this need not be the case. The docking surface 3 is provided with a power switch 1 for turning on and off the docking station. The base 4 is provided with a USB port 5 allowing a wired connection between the base 4 and an external device such as, but limited to a personal computer 13, such as is shown in FIG. 2. As will be explained, at least one printed circuit board is provided within the docking station allowing connection between the connectors 2, the USB port 5 and a port 6 for connection of the electronic device 12 to an external power supply (not shown). As can be appreciated, the docking station can include other parts connecting the device 12 to other devices.

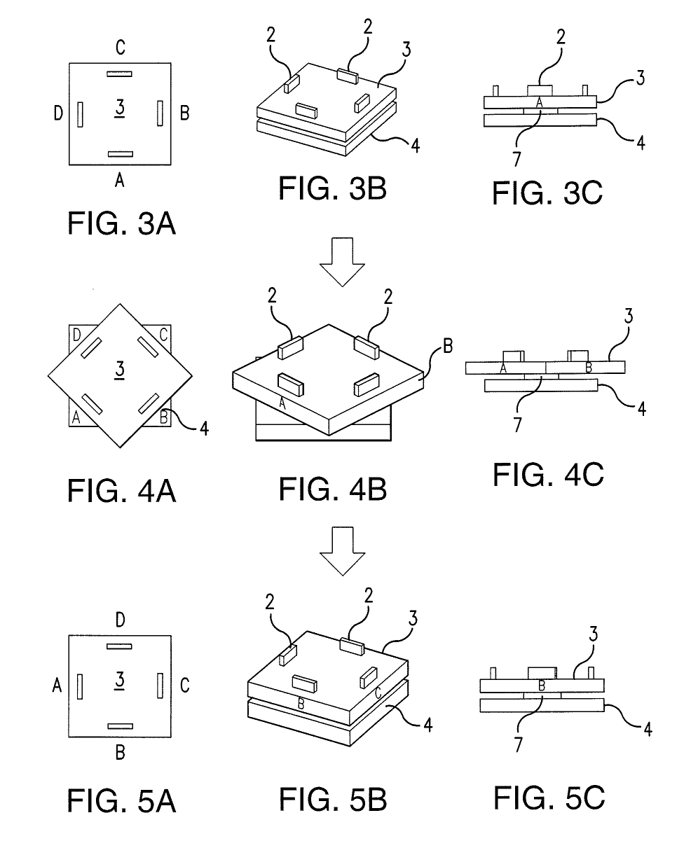

FIG. 2 illustrates the system in operation. As shown, a plurality of electronic portable devices 12 are connected to their respective connectors 2. As can be appreciated, appropriate sockets are provided on the bottom of the electronic devices 12 for connection to their respective connector 2. In one embodiment, the USB port 5 can be connected to a personal computer 13 by a wired connection (not shown) between the personal computer 13 and the USB port 5. Also as shown in FIG. 2, the docking surface 3 has been rotated with respect to the base portion 4. FIGS. 3, 4 and 5 show the manner in which the docking surface 3 can be rotated with respect to the base 4. FIGS. 3A, 4A and 5A show a top view of the rotation as the docking surface 3 moves in a clockwise direction. FIGS. 3B, 4B and 5B show a profile of this clockwise motion. FIGS. 3C, 4C and 5C show a side view of this motion.

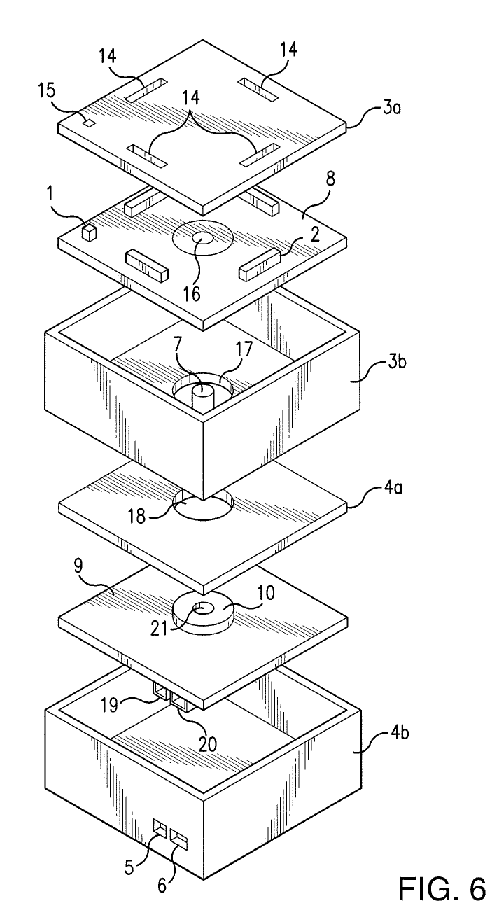

FIG. 6 shows an exploded view of the docking surface according to the present invention. The docking surface 3 includes a cover 3a and a housing 3b into which a first printed circuit board (PCB) 8 is provided. The cover 3a is provided with a plurality of openings 14 through which each of the connectors 2 would pass. Each of the connectors is directly attached to the PCB 8 provided within the housing 3b and under the cover 3a.

The base section 4 includes a cover 4a and a housing 4b. A second printed circuit board (PCB) 9 is provided within the housing 4b and under the cover 4a. Both printed circuit boards 8 and 9 are provided with the appropriate circuitry for connecting the connectors 2 to the USB port 5, the power jack 6, as well as any other electronic device.

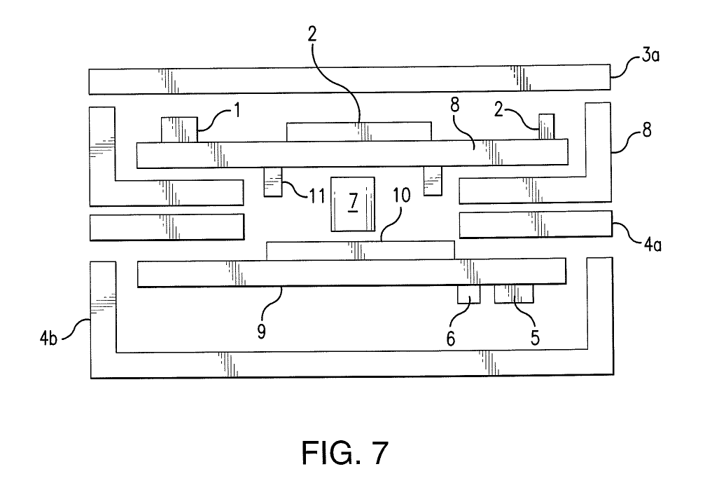

An aperture 17 is provided at the bottom of the base 3b through which a pillar 7 will pass. An aperture 18 is provided in the cover 4a and is aligned with the aperture 17 also allowing the pillar 7 to pass therethrough. The top of the pillar 7 is rotatably contained with hole 16 provided in the PCB 8 at point 16. The bottom of the pillar 7 is fixedly attached to a hole 21 connected to a copper sheet 10 provided on the PCB 9. This particular configuration would easily allow the docking surface 3 including the cover 3a and the housing 3b to be rotated with respect to the base 4 including the cover 4a and housing 4b. The sectional view shown in FIG. 7 shows a partially assembled docking station. This view includes at least one metal contact 11 connected to the underside of the PCB 8. It is noted that while at least one metal contact 11 must be provided in the docking station, a plurality of metal contacts 11 can also be employed as shown by the two metal contacts. When assembled, the metal contacts 11 are physically in contact with the copper sheet 10 applied to the top surface of the PCB 9. The copper sheet can be, but not always laminated to the top surface of the PCB 9. In this manner, there is a direct connection between each of the connectors 2 and lines 19 and 20 connected to the USB port 5 and the power jack 6, respectively. This would allow direct contact between the portable device 12, through the connector 2 to the USB port 5 and power jack 6, through the two PCBs 8 and 9 as well as one or more metal contacts 11. This would enable the docking surface 3 to be rotated about the bore section 4, which breaking electrical contact between the portable devices 12, and any external electrical devices or power supply.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A docking station for connecting one or more portable electronic devices to an external device comprising:
a docking surface provided with at least one connector, said connector adapted to be connected to a portable electronic device;
a base section; and
a device provided between said docking section and said base section for rotatably moving said docking section with respect to said base section.

2. The docking station in accordance with claim 1, said docking section further includes a plurality of connectors, each of said connectors adapted to be connected to a portable electronic device.

3. The docking station in accordance with claim 1, wherein said device provided between said docking station and said base section is a pillar.

4. The docking station in accordance with claim 2, further including means for connecting each of the said connectors to a network.

5. The docking station in accordance with claim 2, further including a means for connecting each of said connectors to a power supply.

6. The docking station in accordance with claim 4, wherein said means for connecting each of said connectors to a network includes a first printed circuit board provided within said docking section and a second printed circuit board provided within said base section.

7. The docking station in accordance with claim 5, wherein said means for connecting each of said connectors to a power supply includes a first printed circuit board provided within said docking section and a second printed circuit board provided within said base section.

8. The docking station in accordance with claim 6, further including at least one metal contact extending between said first printed circuit board and said second printed circuit board.

9. The docking station in accordance with claim 7, further including at least one metal contact extending between said first printed circuit board and said second printed circuit board.

10. The docking station in accordance with claim 6, further including a USB port provided in said base section.

11. The docking station in accordance with claim 7, further including a power jack provided in said base section.

12. The docking station in accordance with claim 2, further including means for connecting each of said connectors to a power supply and means for connecting each of said connectors to a network.

13. The docking station in accordance with claim 12, further including a first printed circuit board provided within said docking section and a second printed circuit board provided within said base section for connecting said connectors to the network and to the power supply.
